(19) United States
(12) Patent Application Publication
(10) Pub. No.: US 2026/0161724 A1
(43) Pub. Date: Jun. 11, 2026

(54) EMBEDDING NATIVE CONTENT INTO A WEBVIEW

(71) Applicant: SAP SE, Walldorf (DE)

(72) Inventors: Walter Mak, North Vancouver (CA); Daryl Kwok, Richmond (CA); Jungwook Jang, Vancouver (CA); Chan Ho Yoon, Coquitlam (CA); Tsz Hong Sung, Richmond (CA); Steffen Koette, Burnaby (CA)

(21) Appl. No.: 18/971,740

(22) Filed: Dec. 6, 2024

(51) Int. Cl. G06F 16/957

(52) U.S. Cl. CPC G06F 16/9577

(57) ABSTRACT

A first application on a mobile device renders first graphical content for display in a first portion of a mobile device display screen. Also, the first application generates a tag as a placeholder for second graphical content to be displayed in a second portion of the screen, where the second graphical content is to be generated by a second application on the mobile device. In response to receiving a request for the second graphical content to be generated, the second application searches a plurality of layers of a WebView until the tag is found. Next, the second application renders the second graphical content as an HTML element into a given WebView layer where the tag was found within the plurality of layers of the WebView. Then, the first application displays the first graphical content and the second graphical content on the mobile device display screen.

### TECHNICAL FIELD

The present disclosure generally relates to embedding native content into a WebView.

### BACKGROUND

The Internet is a collection of distributed computer systems which use a common protocol to communicate between systems. A common use of the Internet is to access websites, which are typically stored on a server and remotely accessed via a computer using a web browser. On a mobile device (e.g., phone, tablet), a user may access content from the Internet using a mobile browser or using a mobile device software application (e.g., Android™ application, iOS™ application). It is noted that a “mobile device software application” may be referred to herein as a “mobile software application” or an “application” for short.

For mobile devices, the content retrieved from the Internet is typically viewed in an application via a WebView. As used herein, the term “WebView” may be defined as a software component that allows an application to display web content without opening a traditional web browser. Alternatively, the term “WebView” may be defined as a web browser that is embedded within an application. In other words, a “WebView” gives a user the ability to view Hypertext Markup Language (HTML) content within an application. However, it can be challenging to present graphical content on a mobile device in a user-friendly fashion when multiple different applications are responsible for providing the graphical content.

### SUMMARY

In some implementations, a first application on a mobile device renders first graphical content for display in a first portion of a mobile device display screen. Also, the first application generates a tag as a placeholder for second graphical content to be displayed in a second portion of the mobile device display screen, where the second graphical content is to be generated by a second application on the mobile device, and where the tag identifies a location and size of the second graphical content within a screen view of the mobile device display screen. The first application sends a request to the second application for the second graphical content to be generated. In response to receiving the request, the second application searches a plurality of layers of a WebView until the tag is found. Next, the second application renders the second graphical content as an HTML element into a given WebView layer where the tag was found within the plurality of layers of the WebView. Then, the first application displays the first graphical content and the second graphical content on the mobile device display screen.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a logical diagram of an example of a system, in accordance with some example implementations of the current subject matter;

FIG. 2 illustrates a graphical user interface (GUI), in accordance with some example implementations of the current subject matter;

FIG. 3 illustrates an example of a responsive story with a native widget, in accordance with some example implementations of the current subject matter;

FIG. 4 illustrates an example of a GUI of a nested scroll view created using WebKit, in accordance with some example implementations of the current subject matter;

FIG. 5 illustrates a process for embedding native content in a WebView, in accordance with some example implementations of the current subject matter;

FIG. 6 illustrates a process for rendering graphical content into an inner scrollview of a WebView, in accordance with some example implementations of the current subject matter;

FIG. 7A depicts an example of a system, in accordance with some example implementations of the current subject matter; and

FIG. 7B depicts another example of a system, in accordance with some example implementations of the current subject matter.

### DETAILED DESCRIPTION

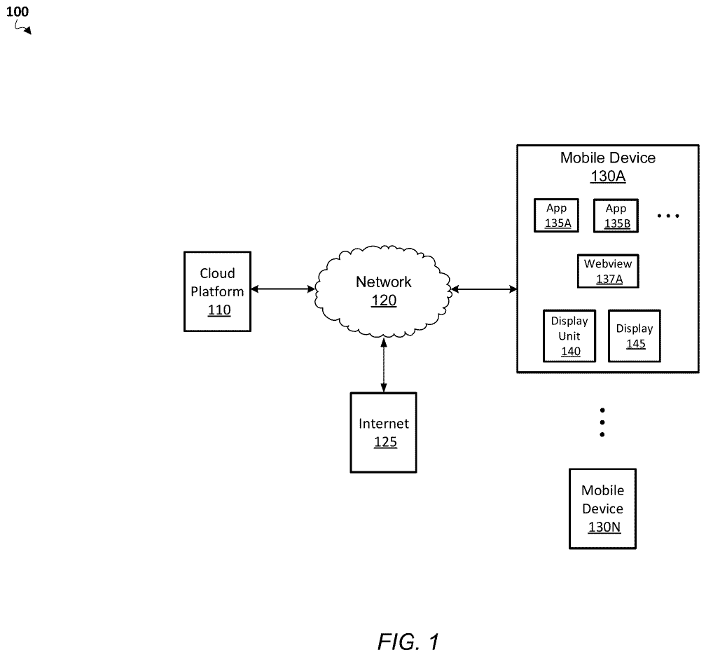

FIG. 1 depicts a diagram illustrating an example of a system 100 consistent with some implementations of the current subject matter. The system 100 may include a plurality of mobile devices including mobile device 130A and mobile device 130N. Mobile devices 130A-130N are representative of any number and type of computing devices and/or computing systems. The mobile devices 130A-130N may execute any number of software applications 135A-135B such as browser-based applications, native applications, and other types of applications. The software applications 135A-135B executing on mobile device 130A may communicate with one or more remote software systems such as cloud platform 110. Remote software executing on cloud platform 110 may store large quantities of application data and offer a variety of functional resources.

The mobile devices 130A-130N are representative of any type of user devices, such as processor-based devices. These processor-based devices may include, for example, a smartphone, a tablet computer, a wearable apparatus, a virtual assistant, an Internet-of-Things (IoT) appliance, and/or the like. Each mobile device 130A-130N may access, via network 120, various data and/or services at the cloud platform 110 and/or Internet 125.

In an example, mobile device 130A includes WebView 137A to display web content without opening a web browser. Application 135A may populate portions of the display area of a graphical user interface (GUI), and application 135A may rely on other native applications (e.g., application 135B) for populating other portions of the display area. In an example, application 135A may render graphical content for display in one or more portions of a screen view while generating placeholders for one or more unpopulated portions of the screen view. These unpopulated portions will be filled with graphical content generated by other applications (e.g., application 135B).

In an example, a first unpopulated portion may be a placeholder for a map generated by native application 135B. As used herein, the term “native application” refers to an application downloaded from an application marketplace (e.g., App Store, Google Play). Application 135A may generate a request for generation of the map and send the request to native application 135B. In response to receiving the request, application 135B may generate the map and determine which layer of the WebView 137A to render the map. Application 135B may then render the map on the determined layer. Application 135A may then cause the combined content to be rendered to display 145 via display unit 140. It is noted that display unit 140 may also be referred to as a display controller or display control unit.

In the example of FIG. 1, the system 100 may include a cloud platform 110, which is representative of any number of cloud platforms or other types of server-based platforms, including on-premise servers and so on. The cloud platform 110 may provide resources that can be shared among a plurality of tenants (e.g., mobile devices 130A-130N). For example, the cloud platform 110 may be configured to provide a variety of services including, for example, software-as-a-service (SaaS), platform-as-a-service (PaaS), infrastructure as a service (IaaS), database as a service (DaaS), and/or the like, and these services can be accessed, via network 120, by one or more tenants of the cloud platform 110. Network 120 may be any wired and/or wireless network including, for example, a public land mobile network (PLMN), a wide area network (WAN), a local area network (LAN), a virtual local area network (VLAN), the Internet, and/or the like.

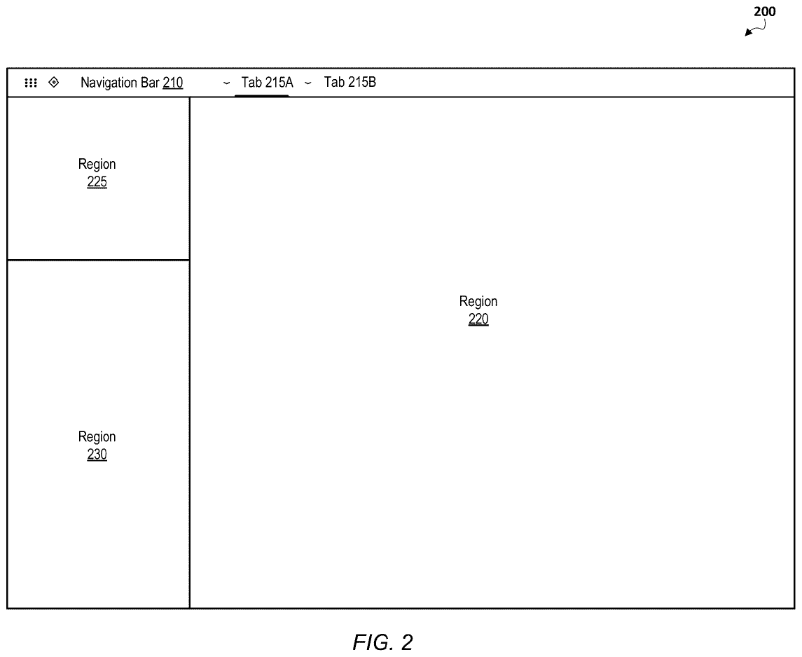

Turning now to FIG. 2, a diagram of a graphical user interface (GUI) 200 is depicted, in accordance with one or more embodiments of the current subject matter. In an example, GUI 200 may be generated by a software application (e.g., application 135A of FIG. 1) executing on a mobile device (e.g., mobile device 130A). As shown in FIG. 2, GUI 200 may include various user interface elements such as navigation bar 210, tab 215A, tab 215B, region 220, region 225, and region 230. It is assumed for the purposes of this example that one or more regions may be rendered by the host application (e.g., application 135A) and one or more regions may be rendered by a native application (e.g., application 135B). For example, when generating GUI 200, the host application may create a placeholder for a given region, and a request may be generated and sent to another application (e.g., application 135B) to have the other application populate the given region with a native widget. It is noted that the terms “widget” and “graphical content” may be used interchangeably herein. Also, a “WebView” may be referred to herein as “webview” without the capitalization of “w” and “v”. Furthermore, a “webview” may be referred to more generally herein as a “view”.

For those regions which will be rendered by the native application, the host application may generate a tag to serve as a placeholder for the region. In this example, it is assumed that regions 220 and 225 will be rendered by the host application and that region 230 will be rendered by the native application. The tag may identify region 230, including the location and size within the screen view of GUI 200. The location may include coordinates to indicate a position within the screen view and the size may indicate a number of pixels in width and length. In other embodiments, the location and size of region 230 may be indicated in other suitable manners.

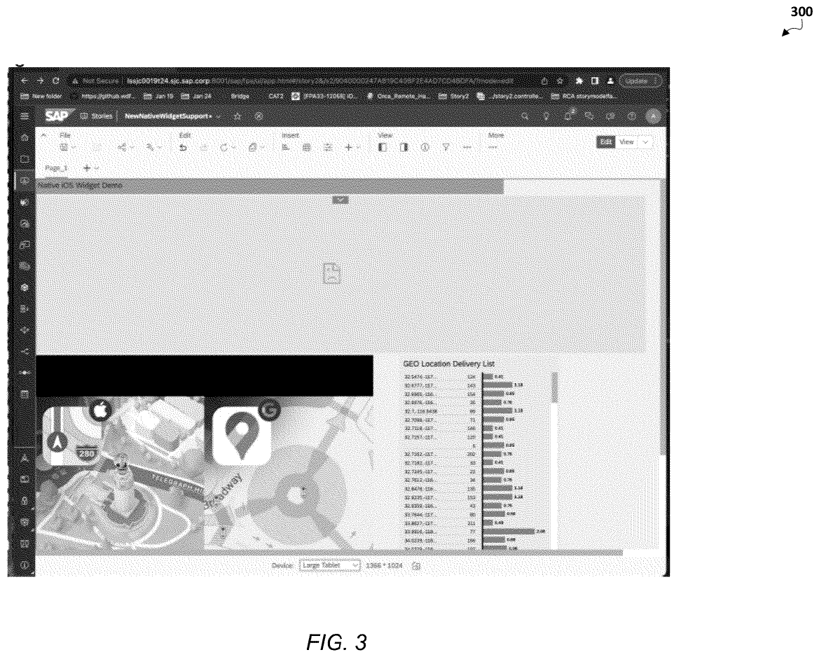

Referring now to FIG. 3, an example of a responsive story 300 with a native widget is depicted, in accordance with one or more embodiments of the current subject matter. FIG. 3 depicts responsive story 300 which is representative of a GUI of a mobile software application for a mobile operating system (e.g., iOS, Android). In an example, the mobile software application will detect a linked analysis event when a native widget needs to be rendered. The mobile software application will send the event information to the native application. The mobile software application will also communicate the native widget information (e.g., the geographic location of a map) to a native application (e.g., Apple® Maps, Google® Maps). The native application will then create the native widget. In an example, a configured image widget will pretend to be a native map widget.

For example, for an iPhone™, the native application may apply a specific geographic location to the Apple Map Kit. The Apple Map Kit will generate a map for the particular geographic location and render the map for inclusion within the screen view at the appropriate screen view coordinates. The mobile software application will then drive the combined rendered content to the display.

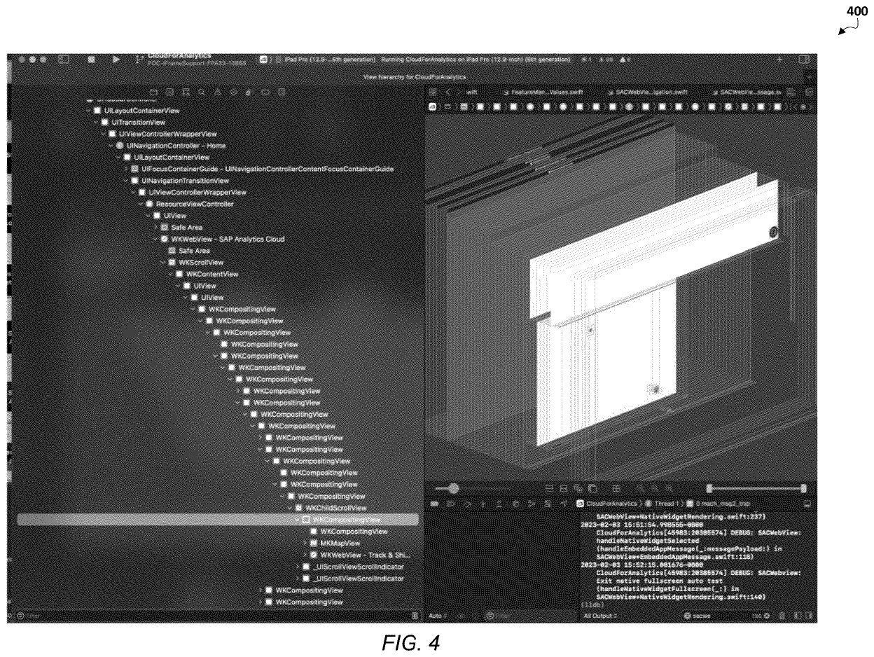

Turning now to FIG. 4, an example of a GUI 400 of a nested scroll view created using WebKit is depicted, in accordance with one or more embodiments of the current subject matter. When injecting a native widget into the WKWebview, a mobile software application (e.g., application 135A) may take advantage of the layered rendering structure of WKWebview and how WKWebview interprets a webpage. WKWebview is a platform-native view that allows iOS software applications to incorporate web content into the application's user interface (UI). WKWebview provides an application programming interface (API) that allows webpages to be rendered in iOS applications.

When a host application generates a request for a native application to embed a native widget in the WKWebview, the native application will find the inner content view of the inner scrollview of the WebView layers. The inner scrollview is the webpage's scrollable content. It is noted that the WKWebview scrollview is not the same as the inner scrollview. The WKWebview scrollview is a top layer and the WKWebview scrollview content is the top layer of the HTML, which is not a scroll container. To find the inner content view of the inner scrollview of the WebView layers, the native application may search the nested scroll and content views created by WebKit. WebKit is a HTML and/or Cascading Style Sheets (CSS) web browser rendering engine that displays webpages based on their markup. In the WKWebview, WebKit translates the HTML document object model (DOM) tree into the WKWebview's layer system.

The native application searches the nested views to find the proper inner content view as shown in the nested scroll view on the left-side of GUI 400. The proper inner content view is the content view that scrolls with the inner division. The native application then renders the native content into the appropriate WebView Layer which is the inner scrollview.

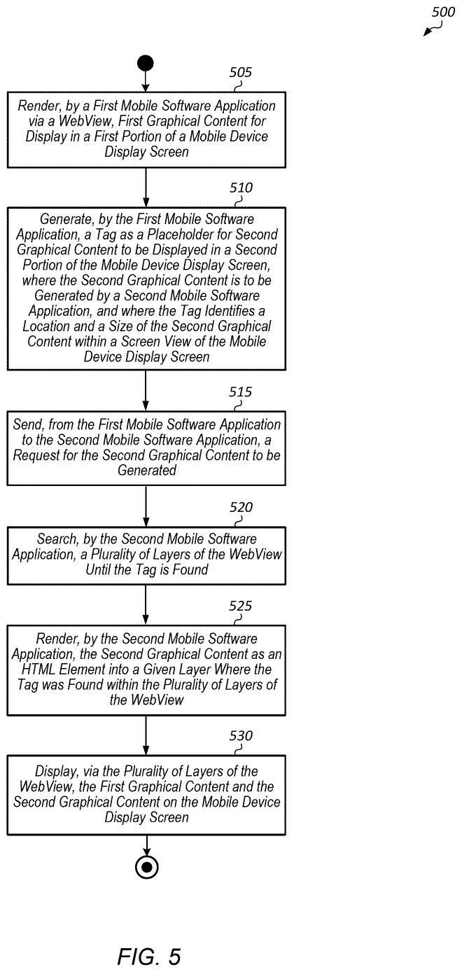

Turning now to FIG. 5, a process for embedding native content in a WebView is depicted, in accordance with one or more embodiments of the current subject matter. A first mobile software application renders, via a WebView, first graphical content for display in a first portion of a mobile device display screen (block 505). Also, the first mobile software application generates a tag as a placeholder for second graphical content to be displayed in a second portion of the mobile device display screen, where the second graphical content is to be generated by a second mobile software application, and where the tag identifies a location and a size of the second graphical content within a screen view of the mobile device display screen (block 510). It is assumed for the purposes of this discussion that the second mobile software application is different from the first mobile software application.

Next, the first mobile software application sends, to the second mobile software application, a request for the second graphical content to be generated (block 515). In response to receiving the request, the second mobile software application searches a plurality of layers of the WebView until the tag is found (block 520). Next, the second mobile software application renders the second graphical content as an HTML element into a given layer where the tag was found within the plurality of layers of the WebView (block 525). Then, the first mobile software application displays, via the plurality of layers of the WebView, the first graphical content and the second graphical content on the mobile device display screen (block 530). In some embodiments, block 530 may be implemented by having the first mobile software application combine additional content (e.g., third graphical content, fourth graphical content) with the first graphical content and the second graphical content, with all of the content being displayed together on the mobile device display screen. The additional content may be generated by the first mobile software application, the second mobile software application, and/or one or more other mobile software applications. In other words, each of three or more portions of the mobile device display screen may have separately rendered graphical content which is displayed simultaneously on the mobile device display screen. After block 530, method 500 may end.

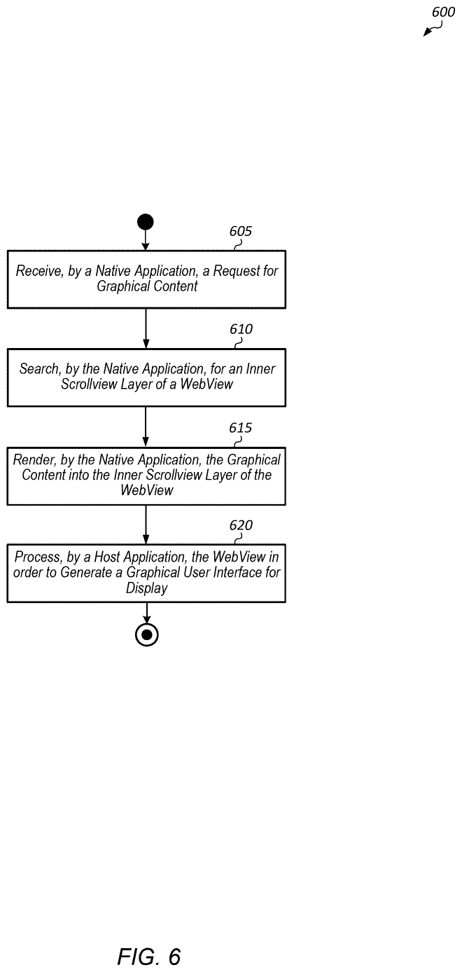

Turning now to FIG. 6, a process for rendering graphical content into an inner scrollview of a WebView is depicted, in accordance with one or more embodiments of the current subject matter. A native application receives a request for graphical content (block 605). In an example, the request is generated by a separate application on a same mobile device as the native application. In response to receiving the request, the native application searches for the inner scrollview layer of a WebView (block 610). Next, the native application renders the graphical content into the inner scrollview layer of the WebView (block 615). Then, a host application processes the WebView in order to generate a graphical user interface for display (block 620). After block 620, method 600 may end.

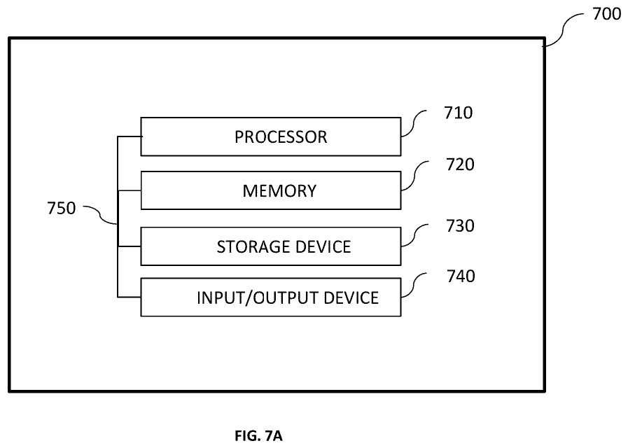

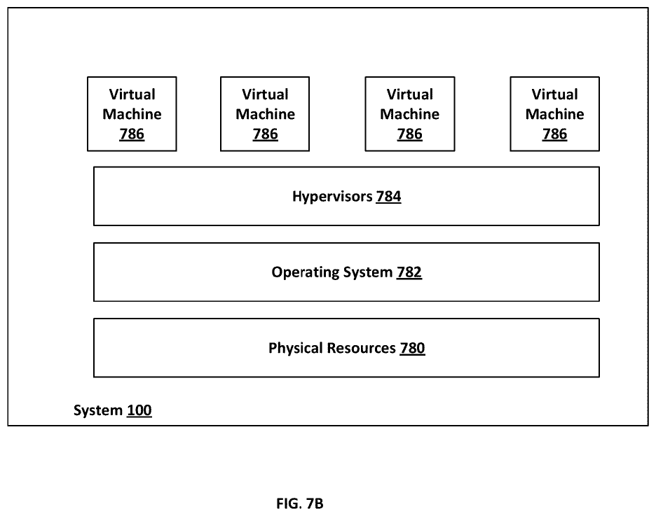

In some implementations, the current subject matter may be configured to be implemented in a system 700, as shown in FIG. 7A. The system 700 may include a processor 710, a memory 720, a storage device 730, and an input/output device 740. Each of the components (e.g., the processor 710, the memory 720, the storage device 730, the I/O device 740) may be interconnected using a system bus 750. The processor 710 may be configured to process instructions for execution within the system 700. In some implementations, the processor 710 may be a single-threaded processor. In alternate implementations, the processor 710 may be a multi-threaded processor. The processor 710 may be further configured to process instructions stored in the memory 720 or on the storage device 730, including receiving or sending information through the input/output device 740. The memory 720 may store information within the system 700. In some implementations, the memory 720 may be a computer-readable medium. In alternate implementations, the memory 720 may be a volatile memory unit. In yet some implementations, the memory 720 may be a non-volatile memory unit. The storage device 730 may be capable of providing mass storage for the system 700. In some implementations, the storage device 730 may be a computer-readable medium. In alternate implementations, the storage device 730 may be a floppy disk device, a hard disk device, an optical disk device, a tape device, non-volatile solid state memory, or any other type of storage device. The input/output device 740 may be configured to provide input/output operations for the system 700. In some implementations, the input/output device 740 may include a touchscreen display capable of displaying graphical user interfaces.

FIG. 7B depicts an example implementation of the system 100 (of FIG. 1). The system 100 may be implemented using various physical resources 780, such as at least one or more hardware servers, at least one storage, at least one memory, at least one network interface, and the like. The system 100 may also be implemented using infrastructure, as noted above, which may include at least one operating system 782 for the physical resources 780 and at least one hypervisor 784 (which may create and run at least one virtual machine 786). For example, each multitenant application may be run on a corresponding virtual machine 786.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable storage medium” refers to any computer program product, apparatus and/or device, such as for example magnetic discs, optical disks, memory, and Programmable Logic Devices (PLDs), used to provide machine instructions and/or data to a programmable processor, including a machine-readable storage medium that receives program instructions as a machine-readable signal. The term “machine-readable signal” refers to any signal used to provide machine instructions and/or data to a programmable processor. The machine-readable storage medium can store such program instructions non-transitorily, such as for example as would a non-transient solid state memory or a magnetic hard drive or any equivalent storage medium. The machine-readable storage medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:
Example 1: A computer-implemented method comprising: rendering, by a first application on a mobile device, first graphical content for display in a first portion of a mobile device display screen; generating, by the first application, a tag as a placeholder for second graphical content to be displayed in a second portion of the mobile device display screen, wherein the second graphical content is to be generated by a second application on the mobile device, and wherein the tag identifies a location and size of the second graphical content within a screen view of the mobile device display screen; sending, from the first application to the second application, a request for the second graphical content to be generated; searching, by the second application, a plurality of layers of a view until the tag is found; rendering, by the second application, the second graphical content as a hypertext markup language (HTML) element into a given view layer where the tag was found within the plurality of layers of the view; and displaying, by the first application, the first graphical content and the second graphical content on the mobile device display screen.
Example 2: The computer-implemented method of Example 1, wherein the view is a webview.
Example 3: The computer-implemented method of any of Examples 1-2, wherein the second application is different from the first application, and wherein the first application and the second application are both executing on a same mobile device.
Example 4: The computer-implemented method of any of Examples 1-3, wherein the tag specifies a location of the second graphical content within a screen view of the mobile device display screen.
Example 5: The computer-implemented method of any of Examples 1-4, wherein the tag specifies a size of the second graphical content.
Example 6: The computer-implemented method of any of Examples 1-5, wherein the given layer is a scrollable layer of the view.
Example 7: The computer-implemented method of any of Examples 1-6, wherein the scrollable layer allows the first graphical content and the second graphical content to scroll together across the mobile device display screen.
Example 8: The computer-implemented method of any of Examples 1-7, wherein the second graphical content is a map.
Example 9: The computer-implemented method of any of Examples 1-8, wherein the second application is a mapping application.
Example 10: The computer-implemented method of any of Examples 1-9, wherein a mobile device operating system is an iPhone operating system (iOS) or an Android operating system.
Example 11: A system comprising: at least one processor; and at least one memory storing instructions that, when executed by the at least one processor, cause operations comprising: receiving, by a first computing device via a first protocol, an indication of a modification made to a first database object on a second computing device; rendering, by a first application on a mobile device, first graphical content for display in a first portion of a mobile device display screen; generating, by the first application, a tag as a placeholder for second graphical content to be displayed in a second portion of the mobile device display screen, wherein the second graphical content is to be generated by a second application on the mobile device, and wherein the tag identifies a location and size of the second graphical content within a screen view of the mobile device display screen; sending, from the first application to the second application, a request for the second graphical content to be generated; searching, by the second application, a plurality of layers of a view until the tag is found; rendering, by the second application, the second graphical content as a hypertext markup language (HTML) element into a given view layer where the tag was found within the plurality of layers of the view; and displaying, by the first application, the first graphical content and the second graphical content on the mobile device display screen.
Example 12: The system of Example 11, wherein the view is a webview.
Example 13: The system of any of Examples 11-12, wherein the second application is different from the first application, and wherein the first application and the second application are both executing on a same mobile device.
Example 14: The system of any of Examples 11-13, wherein the tag specifies a location of the second graphical content within a screen view of the mobile device display screen.
Example 15: The system of any of Examples 11-14, wherein the tag specifies a size of the second graphical content.
Example 16: The system of any of Examples 11-15, wherein the given layer is a scrollable layer of the view.
Example 17: The system of any of Examples 11-16, wherein the scrollable layer allows the first graphical content and the second graphical content to scroll together across the mobile device display screen.
Example 18: The system of any of Examples 11-17, wherein the second graphical content is a map.
Example 19: The system of any of Examples 11-18, wherein the second application is a mapping application.
Example 20: A non-transitory computer readable storage medium storing instructions, which when executed by at least one data processor, result in operations comprising:
   rendering, by a first application on a mobile device, first graphical content for display in a first portion of a mobile device display screen; generating, by the first application, a tag as a placeholder for second graphical content to be displayed in a second portion of the mobile device display screen, wherein the second graphical content is to be generated by a second application on the mobile device, and wherein the tag identifies a location and size of the second graphical content within a screen view of the mobile device display screen; sending, from the first application to the second application, a request for the second graphical content to be generated; searching, by the second application, a plurality of layers of a view until the tag is found; rendering, by the second application, the second graphical content as a hypertext markup language (HTML) element into a given view layer where the tag was found within the plurality of layers of the view; and displaying, by the first application, the first graphical content and the second graphical content on the mobile device display screen.
The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method comprising:
rendering, by a first application on a mobile device, first graphical content for display in a first portion of a mobile device display screen;
generating, by the first application, a tag as a placeholder for second graphical content to be displayed in a second portion of the mobile device display screen, wherein the second graphical content is to be generated by a second application on the mobile device, and wherein the tag identifies a location and size of the second graphical content within a screen view of the mobile device display screen;
sending, from the first application to the second application, a request for the second graphical content to be generated;
searching, by the second application, a plurality of layers of a view until the tag is found;
rendering, by the second application, the second graphical content as a hypertext markup language (HTML) element into a given view layer where the tag was found within the plurality of layers of the view; and
displaying, by the first application, the first graphical content and the second graphical content on the mobile device display screen.

2. The computer-implemented method of claim 1, wherein the view is a webview.

3. The computer-implemented method of claim 1, wherein the second application is different from the first application, and wherein the first application and the second application are both executing on a same mobile device.

4. The computer-implemented method of claim 1, wherein the tag specifies a location of the second graphical content within a screen view of the mobile device display screen.

5. The computer-implemented method of claim 1, wherein the tag specifies a size of the second graphical content.

6. The computer-implemented method of claim 1, wherein the given layer is a scrollable layer of the view.

7. The computer-implemented method of claim 6, wherein the scrollable layer allows the first graphical content and the second graphical content to scroll together across the mobile device display screen.

8. The computer-implemented method of claim 1, wherein the second graphical content is a map.

9. The computer-implemented method of claim 8, wherein the second application is a mapping application.

10. The computer-implemented method of claim 1, wherein a mobile device operating system is an iPhone operating system (iOS) or an Android operating system.

11. A system comprising:
at least one processor; and
at least one memory storing instructions that, when executed by the at least one processor, cause operations comprising:
receiving, by a first computing device via a first protocol, an indication of a modification made to a first database object on a second computing device;
rendering, by a first application on a mobile device, first graphical content for display in a first portion of a mobile device display screen;
generating, by the first application, a tag as a placeholder for second graphical content to be displayed in a second portion of the mobile device display screen, wherein the second graphical content is to be generated by a second application on the mobile device, and wherein the tag identifies a location and size of the second graphical content within a screen view of the mobile device display screen;
sending, from the first application to the second application, a request for the second graphical content to be generated;
searching, by the second application, a plurality of layers of a view until the tag is found;
rendering, by the second application, the second graphical content as a hypertext markup language (HTML) element into a given view layer where the tag was found within the plurality of layers of the view; and
displaying, by the first application, the first graphical content and the second graphical content on the mobile device display screen.

12. The system of claim 11, wherein the view is a webview.

13. The system of claim 11, wherein the second application is different from the first application, and wherein the first application and the second application are both executing on a same mobile device.

14. The system of claim 11, wherein the tag specifies a location of the second graphical content within a screen view of the mobile device display screen.

15. The system of claim 11, wherein the tag specifies a size of the second graphical content.

16. The system of claim 11, wherein the given layer is a scrollable layer of the view.

17. The system of claim 16, wherein the scrollable layer allows the first graphical content and the second graphical content to scroll together across the mobile device display screen.

18. The system of claim 11, wherein the second graphical content is a map.

19. The system of claim 18, wherein the second application is a mapping application.

20. A non-transitory computer readable storage medium storing instructions, which when executed by at least one data processor, result in operations comprising:
rendering, by a first application on a mobile device, first graphical content for display in a first portion of a mobile device display screen;
generating, by the first application, a tag as a placeholder for second graphical content to be displayed in a second portion of the mobile device display screen, wherein the second graphical content is to be generated by a second application on the mobile device, and wherein the tag identifies a location and size of the second graphical content within a screen view of the mobile device display screen;
sending, from the first application to the second application, a request for the second graphical content to be generated;
searching, by the second application, a plurality of layers of a view until the tag is found;
rendering, by the second application, the second graphical content as a hypertext markup language (HTML) element into a given view layer where the tag was found within the plurality of layers of the view; and
displaying, by the first application, the first graphical content and the second graphical content on the mobile device display screen.
